(19) United States
(12) Patent Application Publication
(10) Pub. No.: US 2010/0201663 A1
(43) Pub. Date: Aug. 12, 2010

(54) METHOD OF DRIVING A DISPLAY PANEL AND DISPLAY APPARATUS FOR PERFORMING THE SAME

(75) Inventors: Sung-Hun LEE, Masan-si (KR); Hyun-Seok JEONG, Changwon-si (KR); Doo-Won LEE, Seoul (KR); Dong-Gyu LEE, Daegu (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/503,897

(22) Filed: Jul. 16, 2009

(30) Foreign Application Priority Data
Feb. 6, 2009 (KR) 2009-0009769

(51) Int. Cl. G09G 5/00

(52) U.S. Cl. 345/207

(57) ABSTRACT

A method of driving a display panel includes; sensing an illumination of a surrounding area which surrounds the display panel, and selectively displaying a black line image on the display panel in accordance with the illumination of the surrounding area.

This application claims priority to Korean Patent Application No. 2009-9769, filed on Feb. 6, 2009, and all the benefits accruing therefrom under 35 U.S.C. §119, the contents of which in its entirety are herein incorporated by reference.

### BACKGROUND OF THE INVENTION

1. Field of the Invention

Exemplary embodiments of the present invention relate to a method of driving a display panel and a display apparatus for performing the method. More particularly, exemplary embodiments of the present invention relate to a method of driving a display panel used in a display apparatus and a display apparatus for performing the method.

2. Description of the Related Art

Generally, a typical liquid crystal display (“LCD”) apparatus displays an image using electric and optical characteristics of liquid crystal molecules. The typical LCD apparatus includes an LCD panel displaying the image using light transmittance characteristics of the liquid crystal molecules and a backlight assembly disposed below the LCD panel to provide the LCD panel with light.

The LCD apparatus has various advantages, such as relatively thin thickness, relatively light weight, relatively lower power consumption, etc., compared to other types of display apparatuses. As a result, LCD apparatuses are widely employed in various electronic devices such as monitors, laptop computers, mobile phones, etc. Recently, LCD apparatuses have been used as digital information display (“DID”) devices.

The DID devices may display various information such as digital videos, unlike a conventional electric sign or an advertisement sign, as an apparatus displaying advertisements and information in public places such as airports, subway stations, large shopping malls, theaters, etc.

A DID device may be driven with a high luminance or a low luminance in accordance with the brightness of the surrounding area. For example, the DID device may be driven with the high luminance on a bright day and with the low luminance at night. Otherwise, if the luminance of an image displayed at night is too bright, the DID device may cause visual discomfort to users.

A method of adjusting the luminance of lamps employed as light sources has been generally employed to adjust the luminance of the image. However, in the generally employed method, when a current applied to the lamps, to lower the luminance of the lamps in accordance with the driving characteristic of the lamps, is reduced below a certain level, an error in a light emission amount is generated, so that unevenness of the luminance is generated.

### BRIEF SUMMARY OF THE INVENTION

Exemplary embodiments of the present invention provide a method of driving a display panel for improving the display quality of an image.

Exemplary embodiments of the present invention also provide a display apparatus for performing the above-mentioned method.

According to one exemplary embodiment of the present invention, a method of driving a display panel includes; sensing an illumination of a surrounding area which surrounds the display panel, and selectively displaying a black line image on the display panel in accordance with the illumination of the surrounding area.

In an exemplary embodiment of the present invention, selectively displaying the black line image on the display panel includes; comparing the illumination of the surrounding area with a predetermined threshold value, and inserting the black line image between adjacent normal line images, when the illumination of the surrounding area is less than the predetermined threshold value.

In an exemplary embodiment of the present invention, inserting the black line image between normal line images includes alternately displaying the normal line images and the black line image in a horizontal direction of the display panel.

In an exemplary embodiment of the present invention, inserting the black line image between normal line images includes alternately displaying the normal line image and the black line image in a vertical direction of the display panel.

In an exemplary embodiment of the present invention, inserting the black line image between normal line images includes alternately displaying the normal line images and the black line image in a diagonal direction of the display panel.

According to an exemplary embodiment of the present invention, a display apparatus includes a display panel including; a display panel including a plurality of pixels electrically connected to a plurality of gate lines and a plurality of data lines, respectively, an illumination sensing section which senses an illumination of a surrounding area which surrounds the display panel, and a panel driving section which drives the display panel to selectively display a black line image on the display panel in accordance with illumination of the surrounding area.

In an exemplary embodiment of the present invention, the panel driving section may drive the display panel to insert the black line image between adjacent normal line images, when the illumination of the surrounding area is less than a threshold value.

In an exemplary embodiment of the present invention, the panel driving section may drive the display panel to alternately display the normal line images and the black line image in a horizontal direction of the display panel.

In an exemplary embodiment of the present invention, the panel driving section may drive the display panel to alternately display the normal line images and the black line image in a vertical direction of the display panel.

In an exemplary embodiment of the present invention, the panel driving section drives the display panel to alternately display the normal line images and the black line image in a diagonal direction of the display panel.

In an exemplary embodiment of the present invention, the panel driving section may include; a timing control part which converts gray scale data of an input image signal corresponding to an interval, in which the black line image is inserted, into black data, when the illumination signal is less than the threshold value, and a data driving part which converts the black data into a black data voltage which is output to the data lines.

In an exemplary embodiment of the present invention, the panel driving section may include; a timing control part which inserts null data to the input image signal corresponding to the interval, in which the black line image is inserted, to output the null data, when the illumination signal is less than the threshold value, and a data driving part which converts the null data into a black data voltage which is output to the data lines.

In an exemplary embodiment of the present invention, the panel driving section may include; a first gate driving part connected to odd-numbered gate lines and which outputs gate signals to the odd-numbered gate lines, a second gate driving part connected to even-numbered gate lines and which outputs gate signals to the even-numbered gate lines, and a timing control part which controls the first gate-driving part and the second gate driving part to block the gate signals provided to the gate lines during an interval in which the black line image is inserted.

In an exemplary embodiment of the present invention, gate signals which correspond to the odd-numbered gate lines are blocked during the interval in which the black line image is inserted.

In an exemplary embodiment of the present invention, the gate signals corresponding to the even-numbered gate lines are blocked during the interval in which the black line image is inserted.

According to exemplary embodiments of a method of driving a display panel and exemplary embodiments of a display apparatus for performing the method, the luminance of the display panel is controlled in a method selectively inserting a black line image to the display panel in accordance with the brightness of the surrounding area, thereby improving the display quality of the display apparatus.

### BRIEF DESCRIPTION OF THE DRAWINGS

The above and other aspects, features and advantages of the invention will become more apparent by describing in further detailed exemplary embodiments thereof with reference to the accompanying drawings, in which:

FIG. 1 is a block diagram illustrating a first exemplary embodiment of a display apparatus according to the present invention;

FIG. 2 is a timing diagram showing an exemplary embodiment of a method of driving a display panel in the exemplary embodiment of a display apparatus of FIG. 1;

FIG. 3 is a schematic top plan view illustrating a display state of the exemplary embodiment of a display panel according to the exemplary embodiment of a method of driving the display panel of FIG. 2;

FIG. 4 is a timing diagram showing an exemplary embodiment of a method of driving the display panel in the exemplary embodiment of a display apparatus of FIG. 1;

FIG. 5 is a schematic top plan view illustrating a display state of the exemplary embodiment of a display panel according to the exemplary embodiment of a method of driving the display panel of FIG. 4;

FIG. 6 is a timing diagram showing an exemplary embodiment of a method of driving the display panel in the exemplary embodiment of a display apparatus of FIG. 1;

FIG. 7 is a schematic top plan view illustrating a display state of the exemplary embodiment of a display panel according to the exemplary embodiment of a method of driving the display panel of FIG. 6;

FIG. 8 is a block diagram illustrating a second exemplary embodiment of a display apparatus according to the present invention;

FIG. 9 is a flowchart showing an exemplary embodiment of a method of driving a display panel of the exemplary embodiment of a display apparatus of FIG. 8; and

FIG. 10 is a flowchart showing an exemplary embodiment of a method of driving the display panel of the exemplary embodiment of a display apparatus of FIG. 8.

### DETAILED DESCRIPTION OF THE INVENTION

The invention now will be described more fully hereinafter with reference to the accompanying drawings, in which exemplary embodiments of the present invention are shown. This invention may, however, be embodied in many different forms and should not be construed as limited to the example embodiments set forth herein. Rather, these exemplary embodiments are provided so that this disclosure will be thorough and complete, and will fully convey the scope of the present invention to those skilled in the art. Like reference numerals refer to like elements throughout.

It will be understood that when an element is referred to as being “on” another element, it can be directly on the other element or intervening elements may be present. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-sectional illustrations that are schematic illustrations of idealized exemplary embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

### Exemplary Embodiment 1

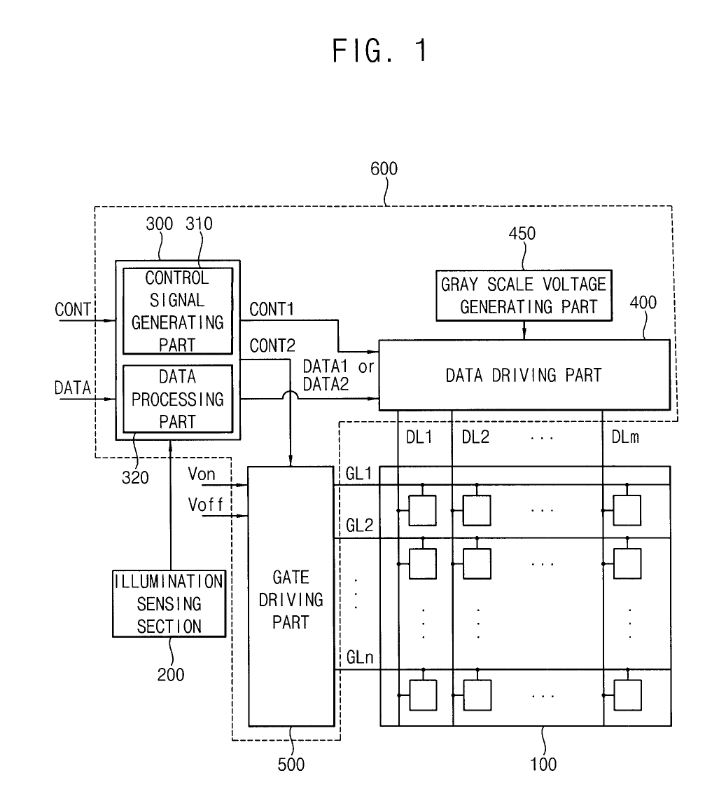

FIG. 1 is a block diagram illustrating an exemplary embodiment of a display apparatus according to a first exemplary embodiment of the present invention.

Referring to FIG. 1, the first exemplary embodiment of a display apparatus may include a display panel 100, an illumination sensing section 200 and a panel driving section 600.

A plurality of gate lines GL1 to GLn and a plurality of data lines DL1 to DLm, disposed substantially perpendicularly to the gate lines GL1 to GLn, are formed on the display panel 100. Here, ‘n’ and ‘m’ are natural numbers. A plurality of pixels 110 displaying an image in accordance with gate signals and data signals that are input through the gate lines GL1 to GLn and the data lines DL1 to DLm are formed in a matrix shape on the display panel 100. Each of the pixels includes a switching element, exemplary embodiments of which include a thin-film transistor (“TFT”) connected to the gate line GL and the data line DL, a liquid crystal capacitor connected to the TFT, and a storage capacitor connected to the TFT. An exemplary embodiments include configurations wherein the storage capacitor may be omitted. Exemplary embodiments include configurations wherein the display panel 100 may include a display substrate, an opposite substrate, and a liquid crystal layer interposed therebetween.

The illumination sensing section 200 is disposed on the interior or the exterior of the display apparatus to sense an illumination of a surrounding area, which surrounds the display panel 100. The illumination sensing section 200 provides a sensed illumination signal corresponding to the sensed illumination of the surrounding area to the panel driving section 600.

The panel driving section 600 processes a black line image to be selectively displayed on the display panel 100, based on the sensed illumination signal by the illumination sensing section 200.

Exemplary embodiments of the panel driving section 600 may include a timing controlling part 300, a data driving part 400, a gray scale voltage generating part 450 and a gate driving part 500.

The timing controlling part 300 receives a control signal CONT and an input image signal DATA provided from an external device such as a graphic controller (not shown). Exemplary embodiments of the control signal CONT may include a main clock signal MCLK, a vertical synchronization signal Vsync, a horizontal synchronization signal Hsync, a data enable signal DE, and various other similar signals. The vertical synchronizing signal Vsync corresponds to a time required for displaying one frame. The horizontal synchronizing signal Hsync corresponds to a time required for displaying one line of the frame. Thus, the horizontal synchronizing signal includes pulses corresponding to the number of pixels included in one line. The data enable signal DE corresponds to a time required for supplying the pixel with data.

Exemplary embodiments of the timing controlling part 300 may include a control signal generating part 310 and a data processing part 320.

The control signal generating part 310 generates a first control signal CONT1 controlling a driving timing of the data driving part 400 and a second control signal CONT2 controlling a driving timing of the gate driving part 500, using the control signal CONT, which was externally supplied. Exemplary embodiments of the first control signal CONT1 may include a horizontal start signal STH, a load signal TP and a data clock signal DCLK. Exemplary embodiments of the second control signal CONT2 may include a vertical start signal STV, a gate clock signal GCLK and an output enable signal OE.

The data processing part 320 processes the black line image to be displayed on the display panel 100, based on the illumination signal applied from the illumination sensing section 200. For example, in one exemplary embodiment, when the illumination signal is greater than or equal to a predetermined threshold value, the data processing part 320 outputs a normal image signal DATA1 corresponding to the input image signal DATA. When the illumination signal is less than the predetermined threshold value, the data processing part 320 inserts the black image signal corresponding to the black line image into the input image signal DATA to output a converted image signal DATA2.

Exemplary embodiments include configurations wherein the data processing part 320 may process the black line image to be displayed in a horizontal direction or a vertical direction on the display panel 100, the black line image being displayed between lines of the normal line images based on the input image data DATA.

In addition, exemplary embodiments include configurations wherein the data processing part 320 may process the black line image to be displayed in a diagonal direction of the display panel 100 between areas where the normal line images are displayed.

Exemplary embodiments include configurations wherein the data processing part 320 may generate the converted image data DATA2 by converting gray scale data of the input image signal DATA corresponding to the area in which the black line image is to be inserted into black data. An exemplary embodiments include configurations wherein the data processing part 320 may generate the converted image signal DATA2 by deleting the gray scale data of the input image signal DATA corresponding to the interval in which the black line image is inserted and by inserting null data into the corresponding interval. The data processing part 320 outputs the converted image signal DATA2 to the data driving part 400.

The data driving part 400 receives the first control signal CONT1, and one of the normal image signal DATA1 and the converted image signal DATA2 from the timing controlling part 300, and receives a plurality of the gray scale voltages from the gray scale voltage generating part 450. The data driving part 400 converts the normal image data DATA or the converted image data DATA2 into analog data voltages using the gray scale voltages received from the gray scale voltage generating part 450, and outputs the data voltages to the data lines DL1 to DLm.

In the exemplary embodiment wherein null data is contained in the converted image signal DATA2, the data driving part 400 converts the null data into the black data voltage which displays the black gray scale when the null data is inserted to the converted image data DATA2 received from the timing controlling part 300.

The gray scale voltage generating part 450 generates the gray scale voltages to output the gray scale voltages to the data driving part 400.

The gate driving part 500 generates a plurality of gate signals which drive the gate lines GL1 to GLn using the second control signal CONT2 and gate driving voltages Von and Voff received from the timing controlling part 300, or some other voltage source. The gate driving part 500 sequentially outputs the gate signals to the gate lines GL1 to GLn.

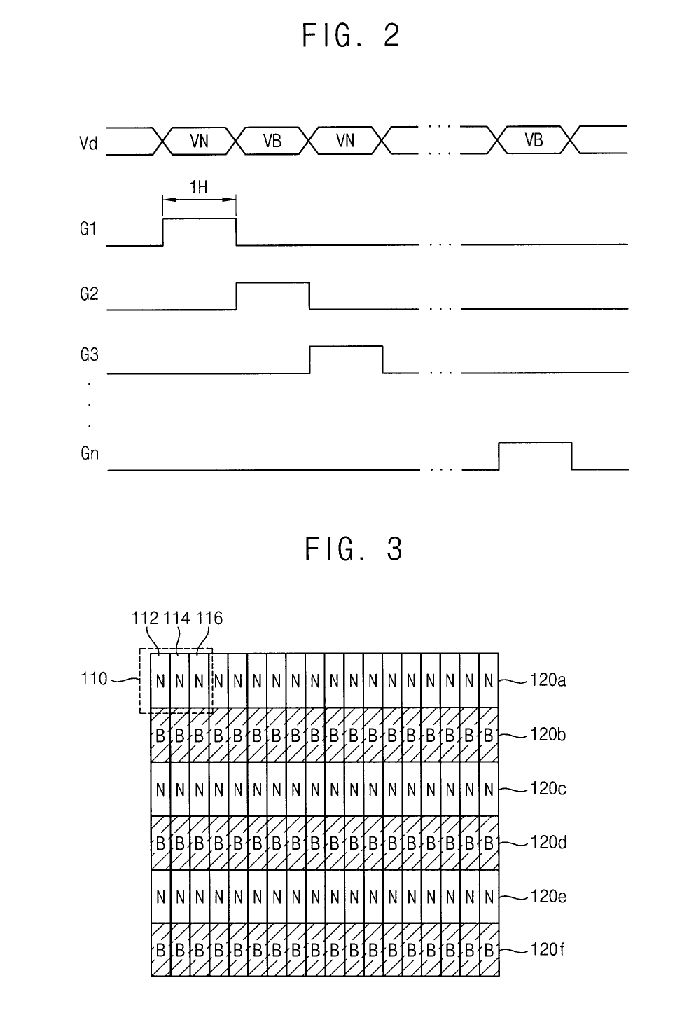

FIG. 2 is a timing diagram showing an exemplary embodiment of a method of driving of a display panel in the exemplary embodiment of a display apparatus of FIG. 1. FIG. 3 is a schematic top plan view illustrating a display state of the exemplary embodiment of a display panel according to the exemplary embodiment of a method of driving the display panel of FIG. 2.

Referring to FIGS. 1 to 3, the data processing part 320 may process a black line image B to be displayed in a horizontal direction of the display panel 100 between the areas in which the normal line images N are displayed, when the illumination signal is less than the threshold value.

The gate driving part 500 generates the gate signals G1 to Gn to sequentially output the gate signals G1 to Gn to the gate lines GL1 to GLn. The data driving part 400 generates the data voltages Vd corresponding to 1H period (wherein ‘H’ is a horizontal period) based on the converted image signal DATA2 received from the data processing part 320, and then outputs the data voltages Vd to the data lines DL1 to DLm.

The data driving part 400 alternately outputs the normal data voltage VN and the black data voltage VB to the data lines DL1 to DLm within a 1H period. Accordingly, the normal data voltage VN and the black data voltage VB are alternately charged in a plurality of horizontal pixel rows 120a to 120f arranged in a direction substantially parallel to a direction of extension of the gate line in 1H period. For example, in one exemplary embodiment when the normal data voltage VN is charged in a first horizontal pixel row 120a connected to a first gate line GL1 turned on by a first gate signal G1, the black data voltage VB is charged in a second horizontal pixel row 120b turned on by a second gate signal G2. The horizontal pixel rows 120a to 120f include a plurality of unit pixels 110, respectively. In the exemplary embodiment wherein the display is a color display, each of the unit pixels 110 may include a red sub-pixel 112, a green sub-pixel and a blue sub-pixel 116.

The normal line image N is displayed on the horizontal pixel rows 120a, 120c and 120e in which the normal data voltage VN is charged, and the black data voltage VB is displayed on the horizontal pixel rows 120b, 120d and 120f in which the black data voltage VB is charged.

Accordingly, the data processing part 320 may control the normal line image N and the black line image B to be alternately displayed in a horizontal direction of the display panel 100 when the illumination signal is less than the threshold value. The display of a plurality of black horizontal pixel rows decreases the luminance of the display due to a decrease in the number of pixels displaying luminances corresponding to higher gray value image signals. Therefore, the panel driving section 600 drives the display panel 100 at a low luminance.

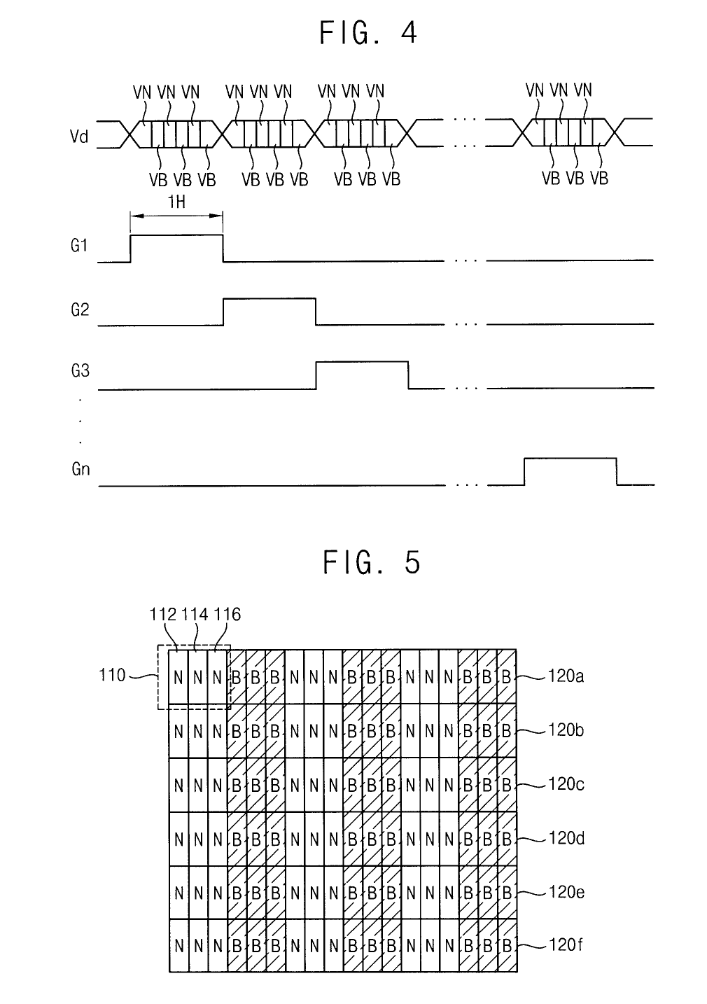

FIG. 4 is a timing diagram showing an exemplary embodiment of a method of driving the display panel in the exemplary embodiment of a display apparatus of FIG. 1. FIG. 5 is a schematic top plan view illustrating a display state of the exemplary embodiment of a display panel according to the exemplary embodiment of a method of driving the display panel of FIG. 4.

Referring to FIGS. 1, 4 and 5, the data processing part 320 may process the black line image B to be displayed in a vertical direction of the display panel 100 between the areas in which the normal line images N are displayed, when the illumination signal is less than the threshold value.

The gate driving part 500 generates the gate signals G1 to Gn, and then sequentially outputs the gate signals G1 to Gn to the gate lines GL1 to GLn. The data driving part 400 generates the data voltages Vd corresponding to 1H period (again, wherein ‘H’ is a horizontal period) based on the converted image signal DATA2 received from the data processing part 320, and then outputs the data voltages Vd to the data lines DL1 to DLm. The data voltages Vd corresponding to the 1H period include the normal data voltage VN and the black data voltage VB.

The normal data voltage VN and the black data voltage VB are alternately charged within a plurality of horizontal pixel rows 120a to 120f arranged in a direction substantially parallel to a direction of extension of the gate line. For example, in one exemplary embodiment when the normal data voltage VN is charged in a first unit pixel of a plurality of unit pixels 110 included in a first horizontal pixel row 120a turned on by a first gate signal G1, the black data voltage VB is charged in a second unit pixel and the normal black data voltage VB is charged in a third unit pixel, and so forth until all the unit pixels in a horizontal pixel row are charged with a data voltage. In one exemplary embodiment, each of the unit pixels 110 may include a red sub-pixel 112, a green sub-pixel and a blue sub-pixel 116.

Accordingly, the data processing part 320 may drive the display panel 100 at the low luminance by controlling the normal line image N and the black line image B to be alternately displayed along a vertical direction of the display panel 100.

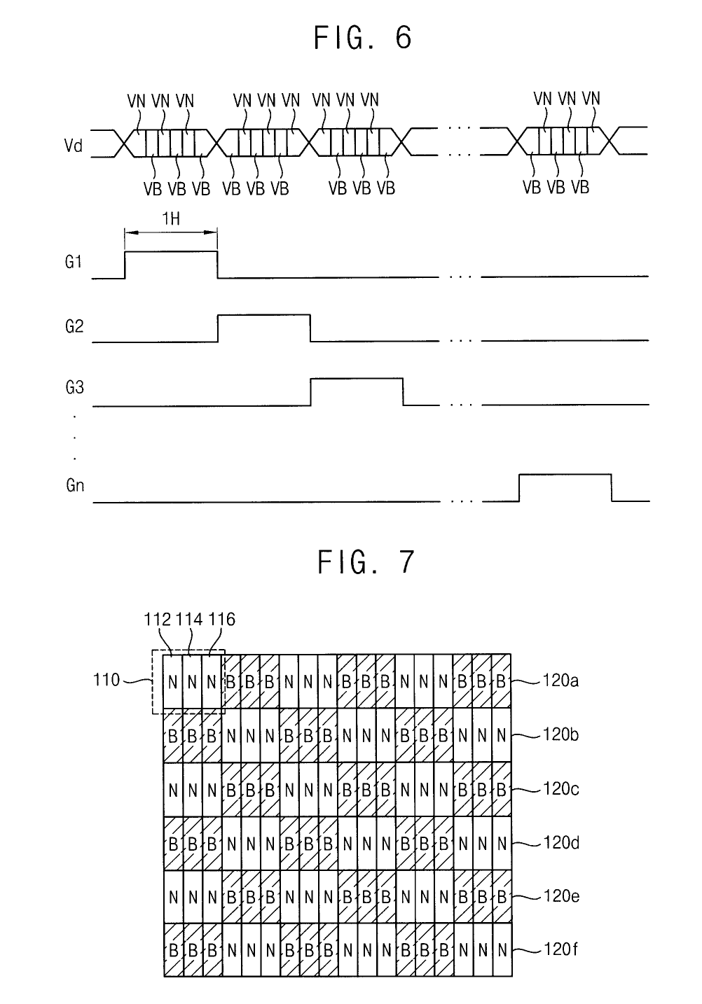

FIG. 6 is a timing diagram showing still an exemplary embodiment of a method of driving the exemplary embodiment of a display panel of FIG. 1. FIG. 7 is a schematic top plan view illustrating a display state of the exemplary embodiment of a display panel according to the exemplary embodiment of a method of driving the display panel of FIG. 6.

Referring to FIGS. 1 and 6, the data processing part 320 may process the black line image B to be displayed in a diagonal direction of the display panel 100 between the normal line images N, when the illumination signal is less than the threshold value.

The gate driving part 500 generates the gate signals G1 to Gn to sequentially output the gate signal G1 to Gn to the gate lines GL1 to GLn (again, wherein ‘n’ is a natural number). The data driving part 400 generates the data voltage Vd corresponding to the 1H period (again, wherein ‘H’ is a horizontal period) based on the converted image signal DATA2 received from the data processing part 320, and then outputs the data voltage Vd to the data lines DL1 to DLm.

The data driving part 400 alternately outputs the normal data voltage VN and the black data voltage VB to the data lines DL1 to DLm during the 1H period. In addition, the data driving part 400 outputs the normal data voltage VN and the black data voltage VB to be reversed to each other to adjacent horizontal pixel rows 120a and 120b in 1H period. When the data voltages output to a first horizontal pixel row 120a begins with a normal data voltage VN, a data voltage output to a second horizontal pixel row 120b, which is adjacent to the first horizontal pixel row 120a, begins with a black data voltage VB.

For example, in one exemplary embodiment, when the data voltages Vd in order of the normal data voltage VN and the black data voltage VB are charged in the first horizontal pixel column 120a turned on by the gate signal G1, the data voltages Vd in order of the black data voltage VB and the normal data voltage VN are charged in the second horizontal pixel column 120b turned on by the second gate signal G1. Also, the data voltages Vd in order of the normal data voltage VN and the black data voltage VB are charged in the third horizontal pixel column 120c turned on by the third gate signal G3. The horizontal pixel columns 120a to 120f include a plurality of unit pixels 110, respectively. In the exemplary embodiment wherein the display is a color display, each of the unit pixels 110 includes the red sub-pixel 112, a green sub-pixel 114 and a blue sub-pixel 116.

Accordingly, the data processing part 320 may drive the display panel 100 at the low luminance by controlling the normal line image N and the black line image N to be alternately displayed in the diagonal direction of the display panel 100.

### Exemplary Embodiment 2

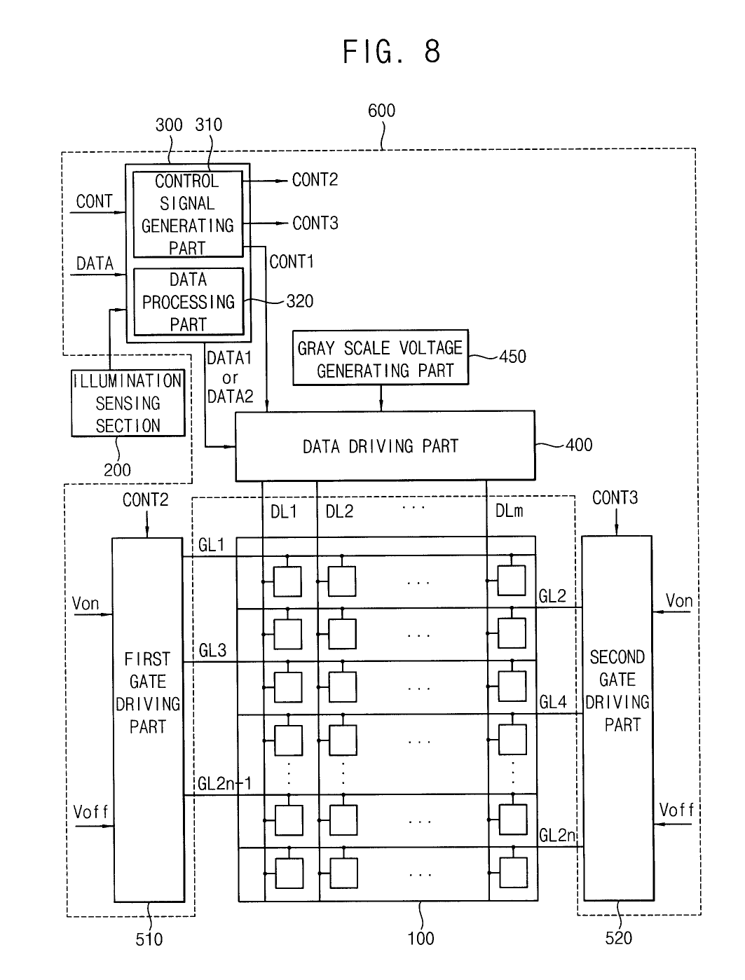

FIG. 8 is a block diagram illustrating a second exemplary embodiment of a display apparatus according to the present invention.

Referring to FIG. 8, the second exemplary embodiment of a display apparatus may include a display panel 100, an illumination sensing section 200 and a panel driving section 600.

A plurality of gate lines GL1 to GL2n and a plurality of data lines DL1 to DLm disposed substantially perpendicular to the gate lines GL1 to GL2n are formed on the display panel 100. A plurality of pixels 110 displaying an image according to the gate signals and the data signals that are respectively input through the gate lines GL1 to GL2n and the data lines DL1 to DLm are formed on the display panel 100 in a substantially matrix shape. Each pixel 110 includes a switching element, one exemplary embodiment of which includes a transistor TR, connected to the gate line GL and the data line DL substantially perpendicular to the gate line GL, a liquid crystal capacitor connected to the transistor TR, and a storage capacitor connected to the transistor TR.

The illumination sensing section 200 is mounted on the interior or the exterior of the display apparatus to sense the illumination of an area surrounding the display apparatus. The illumination sensing section 200 provides the sensed illumination signal to the panel driving section 600.

The panel driving section 600 processes the black line image to be selectively displayed on the display panel 100 based on the sensed illumination signal by the illumination sensing section 200.

In one exemplary embodiment, the panel driving section 600 may include a timing control part 300, a data driving part 500, a gray scale voltage generating part 450, a first gate driving part 510 and a second gate driving part 520.

The timing control part 300 receives a control signal CONT and an input image signal DATA provided from the external device such as a graphic controller (not shown). Exemplary embodiments of the control signal CONT may include a main clock signal MCLK, a vertical synchronizing signal Vsync, a horizontal synchronizing signal Hsync, a data enable signal DE, and other similar signals.

In one exemplary embodiment, the timing control part 300 may include a control signal generating part 310 and a data processing part 320.

The control signal generating part 310 generates a first control signal CONT1 controlling a driving timing of the data driving part 400, a second control signal CONT2 controlling a driving timing of the first gate driving part 510 and a third control signal CONT2 controlling a driving timing of the second gate driving part 520, using the control signal CONT. Exemplary embodiments of the first control signal CONT1 may include a horizontal start signal STH, a load signal TP and a data clock signal DCLK. Exemplary embodiments of the second control signal CONT2 may include a first vertical start signal STV1, a gate clock signal GCLK and an output enable signal OE. Exemplary embodiments of the third control signal CONT3 may include a second vertical start signal STV2, a gate clock signal GCLK and an output enable signal OE.

The data processing part 320 processes the black line image to be displayed on the display panel 100 based on the illumination signal received from the illumination sensing section 200. For example, in one exemplary embodiment, when the illumination signal is greater than or equal to a predetermined threshold value, the data processing part 320 outputs a normal image signal DATA1 corresponding to the input image signal DATA. When the illumination signal is less than a predetermined threshold value, the data processing part 320 outputs a converted image signal DATA2 that is generated by inserting the black image signal corresponding to the black line image into the input image signal DATA.

The data processing part 320 may process the black line image to be displayed in one of the horizontal direction, the vertical direction, and the diagonal direction of the display panel 100 between the normal line images based on the input image signal DATA, similar to the previous exemplary embodiment.

The data processing part 320 may convert gray scale data of the input image signal DATA corresponding to an area in which the black line image is inserted into black data, or delete the gray scale data and insert null data to the corresponding interval to generate the converted image signal DATA2.

The data driving part 400 receives the first control signal CONT1, the normal image signal DATA1, or the converted image signal DATA2 from the timing control part 300, and receives a plurality of gray scale voltages from the gray scale voltage generating part 450. The data driving part 400 converts the normal image signal DATA1 or the converted image signal DATA2 into an analog data voltage to output the data voltage to the data lines DL1 to DLm, using the gray scale voltages.

The gray scale generating part 450 generates the gray scale voltages to output the gray scale voltages to the data driving part 400.

The first gate driving part 510 generates gate signals for driving odd-numbered gate lines GL1, GL3, . . . , GL(2n−1) of the gate lines GL1 to GL2n using the second control signal CONT2 received from the timing control part 300 and gate driving voltages Von and Voff received from an external device. The first gate driving part 510 sequentially outputs the gate signals to the odd-numbered gate lines GL1, GL3, . . . , GL(2n−1).

The second gate driving part 520 generates gate signals for driving even-numbered gate lines GL2, GL4, . . . , GL2n of the gate lines GL1 to GL2n using the third control signal CONT3 received from the timing control part 300 and the gate driving voltages Von and Voff received from the external device. The second gate driving part 520 sequentially outputs the gate signals to the even-numbered gate lines GL2, GL4, . . . , GL2n.

A method controlling the black line image to be displayed in a direction of the horizontal direction, the vertical direction and the diagonal direction between the normal line images to drive the display panel 100 at a low luminance, of the methods of driving a display panel according to the second exemplary embodiment, is substantially the same as the exemplary embodiment of driving the display panel as described with respect to FIG. 2 to FIG. 7, and thus a repetitive detailed explanation will be omitted.

Alternately, according to the second exemplary embodiment, when the illumination signal is less than the threshold value, the display panel 100 may be driven at the low luminance by a method in which the gate signals outputted to some gate lines of the gate lines GL1 to GL2n are blocked. Hereinafter, a method, in which the display panel 100 is driven at the low luminance by controlling a driving of the gate lines GL1 to GL2n, will be explained.

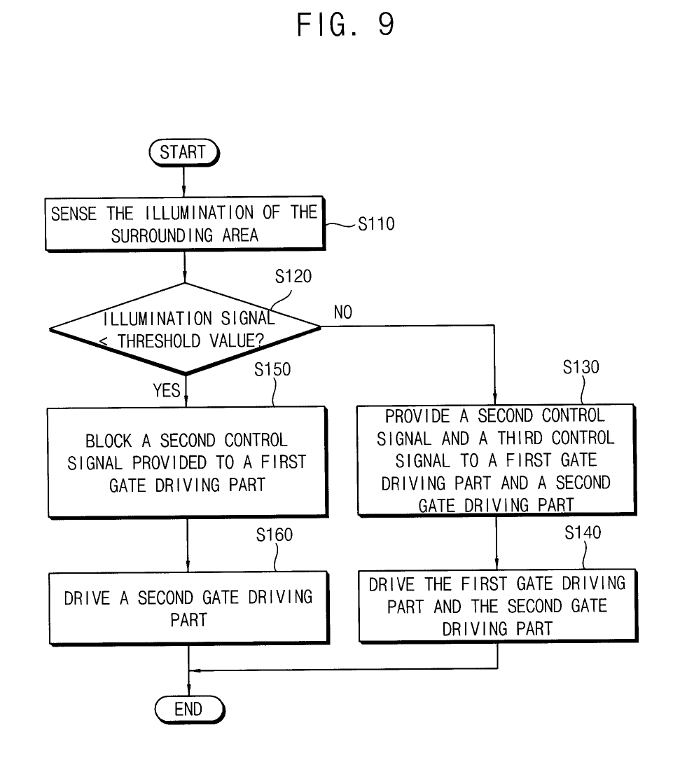

FIG. 9 is a flowchart showing an exemplary embodiment of a method of driving the exemplary embodiment of a display panel of FIG. 8.

Referring to FIGS. 8 and 9, the illumination sensing section 200 senses an illumination of an area surrounding the display panel to generate an illumination signal and provides the illumination signal to the timing control part 300 (step S110).

The timing control part 300 compares the illumination signal with the threshold value (step S120).

In step S120, when the illumination signal is greater than or equal to the threshold value, the timing control part 300 provides the second control signal CONT2 and the third control signal CONT3 to the first gate driving part 510 and the second gate driving part 520 (step S130). The first gate driving part 510 and the second gate driving part 520 generates the gate signals using the second control signal CONT2 and the third control signal CONT3 received from the timing control part 300 to output the gate signals to the corresponding gate lines (step S140). Accordingly, all the gate lines GL1 to GL2n are driven.

In step S120, when the illumination signal is less than the threshold value, the timing control part 300 outputs the third control signals CONT3 to the second gate driving part 520, and blocks the second control signal CONT2 provided to the first gate driving part 510 (step S150). An exemplary embodiments include configurations wherein when the illumination signal is less than the threshold value, the timing control part 300 simply does not generate the second control signal CONT2. The second gate driving part 520 generates the gate signals based on the third control signal CONT3 to output the gate signals to the even-numbered gate lines GL2, GL4, . . . , GL2n (step S160). Accordingly, the even-numbered gate lines GL2, GL4, . . . , GL2n electrically connected to the second gate driving part 520 of the gate lines GL1 to GL2n are the only driven gate lines.

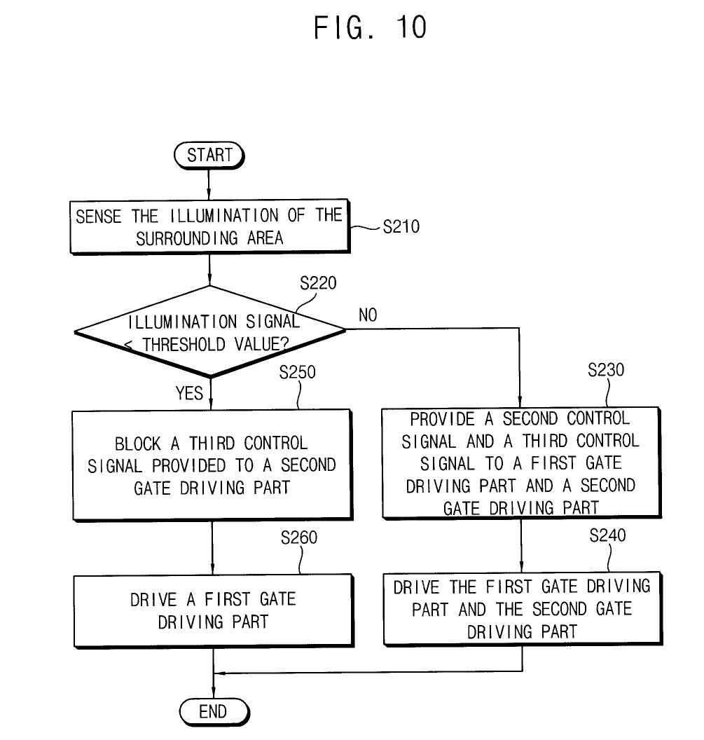

FIG. 10 is a flowchart showing an exemplary embodiment of a method of driving the exemplary embodiment of a display panel of FIG. 8.

Referring to FIGS. 8 and 10, the illumination sensing section 200 senses an illumination of an area surrounding the display apparatus to generate an illumination signal and provides the illumination signal to the timing control part 300 (step S210).

The timing control part 300 compares the illumination signal with the threshold value (step S220).

In step S220, when the illumination signal is greater than or equal to the threshold value, the timing control part 300 transmits the second control signal CONT2 and the third control signal CONT3 to the first gate driving part 510 and the second gate driving part 520 (step S230). The first gate driving part 510 and the second gate driving part 520 generates the gate signals using the second control signal CONT2 and the third control signal CONT3 received from the timing control part 300 to output the gate signals to the corresponding gate lines (step S240). Accordingly, all the gate lines GL1 to GL2n are driven.

In step S220, when the illumination signal is less than the threshold value, the timing control part 300 outputs the second control signal CONT2 to the first gate driving part 510 and blocks the third control signal CONT3 provided to the second gate driving part 520 (step S250). The first gate driving part 510 generates the gate signals based on the second control signal CONT2 to output the gate signals to the odd-numbered gate lines GL1, GL3, . . . , GL(2n−1) (step S260). Accordingly, the odd-numbered gate lines GL1, GL3, . . . , GL2n−1 electrically connected to the first gate driving part 510 of the gate lines GL1 to GL2n are the only driven gate lines.

Accordingly, when the illumination signal is less than the threshold value, the gate signals applied to the odd-numbered gate lines GL1, GL3, . . . , GL(2n−1) or the even-numbered gate lines GL2, GL4, . . . , GL2n are blocked, thereby driving the display panel 100 at a low luminance. Because the even or odd gate lines do not receive a driving signal, the unit pixels connected thereto are not switched on to receive data voltages, and therefore they remain in a default configuration, which in this exemplary embodiment corresponds to a low gray value. Therefore, approximately half of the unit pixels in the display may be configured to be in a dark state, thereby reducing the average luminance of the display.

As described above, according to exemplary embodiments of the present invention, a black line image is selectively inserted to the display panel in accordance with the brightness of the surrounding area, thereby controlling the luminance of an image displayed on the display panel. Accordingly, the display quality of an image displayed on the display apparatus may be improved.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific example embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. A method of driving a display panel, the method comprising:
sensing an illumination of a surrounding area which surrounds the display panel; and
selectively displaying a black line image on the display panel in accordance with the illumination of the surrounding area.

2. The method of claim 1, wherein selectively displaying a black line image on the display panel comprises:
comparing the illumination of the surrounding area with a predetermined threshold value; and
inserting the black line image between adjacent normal line images, when the illumination of the surrounding area is less than the predetermined threshold value.

3. The method of claim 2, wherein inserting the black line image between normal line images comprises alternately displaying the normal line images and the black line image in a horizontal direction of the display panel.

4. The method of claim 2, wherein inserting the black line image between normal line images comprises alternately displaying the normal line images and the black line image in a vertical direction of the display panel.

5. The method of claim 2, wherein inserting the black line image between normal line images comprises alternately displaying the normal line images and the black line image in a diagonal direction of the display panel.

6. A display apparatus comprising:
a display panel comprising a plurality of pixels electrically connected to a plurality of gate lines and a plurality of data lines, respectively;
an illumination sensing section which senses an illumination of a surrounding area which surrounds the display panel; and
a panel driving section which drives the display panel to selectively display a black line image on the display panel in accordance with the illumination of the surrounding area.

7. The display apparatus of claim 6, wherein the panel driving section drives the display panel to insert the black line image between adjacent normal line images, when the illumination of the surrounding area is less than a threshold value.

8. The display apparatus of claim 7, wherein the panel driving section drives the display panel to alternately display the normal line images and the black line image in a horizontal direction of the display panel.

9. The display apparatus of claim 7, wherein the panel driving section drives the display panel to alternately display the normal line images and the black line image in a vertical direction of the display panel.

10. The display apparatus of claim 7, wherein the panel driving section drives the display panel to alternately display the normal line images and the black line image in a diagonal direction of the display panel.

11. The display apparatus of claim 7, wherein the panel driving section comprises:
a timing control part which converts gray scale data of an input image signal corresponding to an interval, in which the black line image is inserted, into black data, when the illumination signal is less than the threshold value; and
a data driving part which converts the black data into a black data voltage which is output to the data lines.

12. The display apparatus of claim 11, wherein the panel driving section comprises:
a timing control part which inserts null data to the input image signal corresponding to the interval, in which the black line image is inserted, to output the null data, when the illumination signal is less than the threshold value; and
a data driving part which converts the null data into a black data voltage which is output to the data lines.

13. The display apparatus of claim 7, wherein the panel driving section comprises:
a first gate driving part connected to odd-numbered gate lines and which outputs gate signals to the odd-numbered gate lines;
a second gate driving part connected to even-numbered gate lines and which outputs gate signals to the even-numbered gate lines; and
a timing control part which controls the first gate driving part and the second gate driving part to block the gate signals provided to the gate lines during an interval in which the black line image is inserted.

14. The display apparatus of claim 13, wherein gate signals corresponding to the odd-numbered gate lines are blocked during the interval in which the black line image is inserted.

15. The display apparatus of claim 13, wherein the gate signals corresponding to the even-numbered gate lines are blocked during the interval in which the black line image is inserted.
